(19) United States
(12) Patent Application Publication
(10) Pub. No.: US 2015/0301699 A1
(43) Pub. Date: Oct. 22, 2015

(54) METHODS, SYSTEMS, AND MEDIA FOR MEDIA GUIDANCE

(71) Applicant: Google Inc., Mountain View, CA (US)

(72) Inventors: Aaron Joseph Wheeler, San Francisco, CA (US); Jennifer Arden, San Francisco, CA (US)

(21) Appl. No.: 14/611,819

(22) Filed: Feb. 2, 2015

Related U.S. Application Data
(60) Provisional application No. 61/980,120, filed on Apr. 16, 2014.

(51) Int. Cl. G06F 3/0482; G06F 3/0484

(52) U.S. Cl. CPC G06F 3/0482; G06F 3/0484

(57) ABSTRACT

Methods, systems, and media for media guidance are provided. In some embodiments, the method comprises: receiving a request to browse through a plurality of media content items; causing a plurality of media interfaces to be presented in response to receiving the request, wherein each of the plurality of media interfaces is a selectable object and includes information associated with a media content item placed within the interface; determining that a media interface from the plurality of media interfaces has been selected; causing a media content item corresponding to the selected media interface to be played back in a media player window in response to determining that the media interface has been selected; and concurrently with causing the media content item to be played back in the media player window, causing the selected media interface to be presented for a predetermined period of time, wherein the selected media interface identifies the media content item.

### CROSS-REFERENCE TO RELATED APPLICATION

The application claims the benefit of U.S. Provisional Patent Application No. 61/980,120, filed Apr. 16, 2014, which is hereby incorporated by reference herein in its entirety.

### TECHNICAL FIELD

The disclosed subject matter relates to methods, systems, and media for media guidance. More particularly, the disclosed subject matter relates to providing media guidance with persistent media interfaces.

### BACKGROUND

Users are increasingly interested in streaming media content to their televisions. However, streaming media content is often optimized for presentation on computers having a mouse, a keyboard, and/or a touchscreen. When such media content is presented on televisions, users can find it difficult to browse through media content items and/or suggestions while watching a particular media content item.

Accordingly, it is desirable to provide new methods, systems, and media for media guidance.

### SUMMARY

In accordance with various embodiments of the disclosed subject matter, methods, systems, and media for media guidance are provided.

In accordance with some embodiments of the disclosed subject matter, a method for media guidance is provided, the method comprising: receiving a request to browse through a plurality of media content items; causing, using a hardware processor, a plurality of media interfaces to be presented in response to receiving the request, wherein each of the plurality of media interfaces is a selectable object and includes information associated with a media content item placed within the interface; determining that a media interface from the plurality of media interfaces has been selected; causing a media content item corresponding to the selected media interface to be played back in a media player window in response to determining that the media interface has been selected; and concurrently with causing the media content item to be played back in the media player window, causing the selected media interface to be presented for a predetermined period of time, wherein the selected media interface identifies the media content item.

In accordance with some embodiments of the disclosed subject matter, a system for media guidance are provided, the system comprising: a hardware processor that is configured to: receive a request to browse through a plurality of media content items; cause a plurality of media interfaces to be presented in response to receiving the request, wherein each of the plurality of media interfaces is a selectable object and includes information associated with a media content item placed within the interface; determine that a media interface from the plurality of media interfaces has been selected; cause a media content item corresponding to the selected media interface to be played back in a media player window in response to determining that the media interface has been selected; and concurrently with causing the media content item to be played back in the media player window, cause the selected media interface to be presented for a predetermined period of time, wherein the selected media interface identifies the media content item.

In accordance with some embodiments of the disclosed subject matter, non-transitory computer-readable media containing computer executable instructions that, when executed by a processor, cause the processor to perform a method for media guidance are provided, the method comprising: receiving a request to browse through a plurality of media content items; causing a plurality of media interfaces to be presented in response to receiving the request, wherein each of the plurality of media interfaces is a selectable object and includes information associated with a media content item placed within the interface; determining that a media interface from the plurality of media interfaces has been selected; causing a media content item corresponding to the selected media interface to be played back in a media player window in response to determining that the media interface has been selected; and concurrently with causing the media content item to be played back in the media player window, causing the selected media interface to be presented for a predetermined period of time, wherein the selected media interface identifies the media content item.

In accordance with some embodiments of the disclosed subject matter, a system for media guidance is provided, the system comprising: means for receiving a request to browse through a plurality of media content items; means for causing a plurality of media interfaces to be presented in response to receiving the request, wherein each of the plurality of media interfaces is a selectable object and includes information associated with a media content item placed within the interface; means for determining that a media interface from the plurality of media interfaces has been selected; means for causing a media content item corresponding to the selected media interface to be played back in a media player window in response to determining that the media interface has been selected; and concurrently with causing the media content item to be played back in the media player window, means for causing the selected media interface to be presented for a predetermined period of time, wherein the selected media interface identifies the media content item.

In some embodiments, the information on each of the plurality of media interfaces is based on metadata associated with each of the plurality of media content items.

In some embodiments, the media content item represented by at least one of the plurality of media interfaces represents a plurality of media content items and a first media content item from the plurality of media content items is presented in the player window.

In some embodiments, the media content item represented by at least one of the plurality of media interfaces is a single media content item and the single media content item is presented in the player window.

In some embodiments, the system further comprises: means for receiving a request to change the concurrently presented selected media interface to a second media interface, wherein the second media interface represents an item of media content related to the media content being played back in the player window; and means for causing the second media interface to be concurrently presented with the player window for a second predetermined period of time in response to the request.

In some embodiments, the system further comprises: means for determining that the second media interface has been selected; and means for causing a media content item corresponding to the second media interface to be played back in the player window in response to determining that the second media interface has been selected.

In some embodiments, the system further comprises: means for causing the selected media interface to be presented for the predetermined period of time; means for causing the selected media interface to no longer be presented after the predetermined period of time; means for receiving a request to display the selected media interface after the predetermined period of time; and means for causing the selected media interface to be concurrently presented with the player window for a third predetermined period of time.

In some embodiments, the system further comprises means for modifying one or more visual features of the selected media interface in response to playing back the corresponding media content item in the media player window.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 shows an illustrative example of a user interface for presenting a set of media interfaces in accordance with some embodiments of the disclosed subject matter.

FIG. 2 shows an illustrative example of a user interface for concurrently presenting an item of media content and an associated media interface in accordance with some embodiments of the disclosed subject matter.

FIG. 3 shows a schematic diagram of an illustrative example of a system for media guidance in accordance with some embodiments of the disclosed subject matter.

FIG. 4 shows an illustrative example of hardware that can be used in a server and/or a user device in accordance with some embodiments of the disclosed subject matter.

FIG. 5 shows an illustrative example of a process for media guidance in accordance with some embodiments of the disclosed subject matter.

### DETAILED DESCRIPTION

Methods, systems, and media for media guidance are provided.

In accordance with some embodiments, media interfaces representing media content items can be presented in a user interface, thereby allowing a user to browse and/or navigate through multiple media interfaces to select a media content item to consume. These media interfaces can be presented, for example, in a grid of media interfaces, as a column of media interfaces, as a row of media interfaces, as multiple rows of media interfaces with each row representing a group of related media interfaces, and/or using any other suitable technique or techniques.

In some embodiments, the selection of a media interface by the user can cause the presentation of the associated media content item. For example, in response to receiving one or more directional inputs (e.g., issued by a user input device) to highlight a particular media interface and in response to receiving a user selection of the particular media interface, the corresponding media content item can be presented to the user. In some embodiments, the selected media interface can be concurrently presented with the associated media content item, for example, by presenting both the selected media interface and the media content item within a single media player window.

In some embodiments, a media interface that is presented concurrently with the associated media content item can be interacted with, for example, within the media player window. In such embodiments, mechanisms described herein can allow a user to navigate through a selection of media interfaces within the media player window while a media content item is simultaneously being presented within the media player window. For example, in response to playing back a video content item within a list of video content items, the media interface that identifies the currently played back content item can be presented along with the video content item, where the user can navigate to other media interfaces that identify the other video content items in the list.

It should be noted that, in some embodiments, a media interface can represent a single media content item and/or a collection of media content items (e.g., a playlist of videos, a playlist of songs, a collection of images, etc.). In some embodiments, a selection of media interfaces presented in a user interface can include a combination of one or more media interfaces each representing single media content items and one or more media interfaces each representing a collection of media content items. For example, in response to concurrently presenting a media interface along with media content identified by the media interface, the user can be provided with an opportunity to navigate through media interfaces that represent other single media content items and/or media interfaces that represent a collection of media content items.

It should also be noted that media content items can be any suitable media content. For example, media content can include audio and/or video media content. As another example, media content can include print media content or image media content. As still another example, media content can include a collection of media content, such as a playlist of videos, a playlist of songs, a collection of images, etc. As a further example, media content can include subscription based media content, such as podcasts, online magazine subscriptions, etc. As another further example, media content can include interactive media content, such as applications and video games. As another further example, media content can include any suitable combination thereof and/or any other suitable media content.

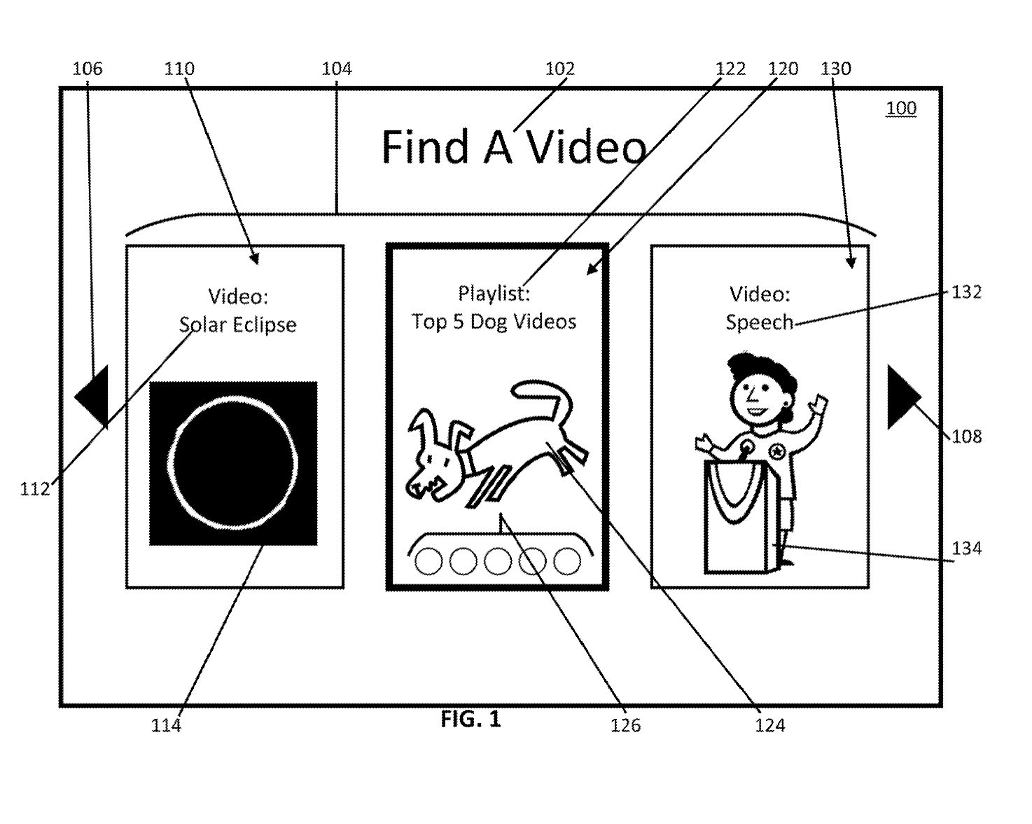

Turning to FIG. 1, an example 100 of a user interface that includes multiple media interfaces is illustrated in accordance with some embodiments. As shown, user interface 100 can include a title 102, multiple media interfaces 104, and display controls 106 and 108.

Title 102 can indicate the content of user interface 100. For example, as shown in FIG. 1, title 102 can include a block of text. In some embodiments, title 102 can include any suitable text, images, icons, graphics, animations, videos, and/or any other suitable content. The position of title 102 in user interface 100 is merely an example, and title 102 can be presented in any suitable position. In some embodiments, title 102 can be omitted.

Media interfaces 104 can include a collection of individual media interfaces, for example, media interfaces 110, 120, and 130, as shown in FIG. 1. Although three media interfaces are shown in FIG. 1, any suitable number of media interfaces, including none, can be presented.

Media interfaces 104 can be presented based on any suitable information and can be presented in response to any suitable action. For example, in some embodiments, media interfaces 104 can be presented based on a search query from a user. As a more particular example, in some embodiments, media interfaces 110, 120, and/or 130 can be selected and/or generated to correspond to one or more media content items which match a search query submitted by a user (e.g., a query for media content items in a particular genre, a query for a particular media content item, and/or any other suitable type of query). As another example, in some embodiments, media interfaces 104 can be presented based on determining a particular web page has been loaded (e.g., a home page corresponding to a provider of the media interfaces, and/or any other suitable web page). In some embodiments, media interfaces 110, 120, and/or 130 can be selected and/or created to correspond to media content items which meet particular criteria. As a more particular example, in some embodiments, the presented media interfaces can represent a group of popular media content items (e.g., the X most popular media content items over a particular time period, and/or any other suitable metric of popularity).

Individual media interfaces within the multiple media interfaces 104 can be associated with any suitable type or types of media content. For example, as shown in FIG. 1, media interfaces 110 and 130 are each associated with a single video. As another example, as also shown in FIG. 1, media interface 120 is associated with a playlist which contains multiple videos (or links to videos). As yet another example, a media interface can be associated with a song and/or any other piece of audio content. As still another example, a media interface can be associated with a playlist which contains individual items of audio content. In some embodiments, a playlist can contain a combination of video content, audio content, and/or any other suitable media content (e.g., images, a slideshow of images, etc.). In some embodiments, any suitable number of media content items, and any suitable type of media content items, can be included in a playlist.

Individual media interfaces can include titles, such as titles 112, 122, and 132. Titles 112, 122, and/or 132 can indicate the content of the media content associated with a corresponding media interface. For example, as shown in FIG. 1, titles 112, 122, and/or 132 can indicate whether the media content associated with the corresponding media interface is a single media content item (e.g., a video) or a playlist (e.g., a collection of videos). As another example, as shown in FIG. 1, titles 112, 122, and/or 132 can indicate a topic of the media content associated with the corresponding media interface. In some embodiments, titles 112, 122, and/or 132 can include any suitable text, images, icons, graphics, animations, and/or any other suitable content. The positions of titles 112, 122, and 132 are shown merely as examples and can be presented in any suitable positions. In some embodiments, titles 112, 122, and/or 132 can be omitted.

Individual media interfaces can include thumbnail images, such as thumbnail images 114, 124, and 134. Thumbnail images 114, 124, and 134 can be any suitable image which represents the media content associated with the corresponding media interface. For example, as shown in FIG. 1, thumbnail images 114, 124, and/or 134 can be images which represent the topic of the media content associated with the corresponding media interface. As another example, in some embodiments, thumbnail images 114, 124, and/or 134 can include a screen capture from a frame of the corresponding media content items. As yet another example, in some embodiments, thumbnail images 114, 124, and/or 134 can represent the creator of the media content associated with the corresponding media interface (e.g., a logo of an entity, and/or any other suitable representation of the creator of the media content). In some embodiments, thumbnail images 114, 124, and 134 can include any suitable images, icons, graphics, animations, and/or any other suitable content. In some embodiments, thumbnail images 114, 124, and 134 can be omitted.

It should be noted that elements, such as titles, thumbnail images, and/or other media identifier elements, that are presented can be based on one or more items of metadata associated with the media content with which the media identifier element is associated. For example, the media identifier element can include title information based on title metadata of the media content. As another example, the media identifier element can include an image based on thumbnail metadata of the media content and/or a frame of image data from the data of the media content.

Individual media interfaces associated with a playlist or collection of media content items, for example, media interface 120 as shown in FIG. 1, can include a playlist indicator 126. Playlist indicator 126 can indicate the number of media content items contained in the playlist in any suitable manner. For example, as shown in FIG. 1, playlist indicator 126 can include a series of icons, each of which corresponds to one media content item within the playlist. In a more particular example, playlist indicator 126 can include a playback indicator that indicates which of the media content items within the playlist is currently being played back (e.g., a red circle) and a navigation indicator that indicates which of the media content items within the playlist has been navigated to (e.g., a gray circle). Any suitable icon(s) (e.g., squares, triangles, images, and/or any other suitable icon) can be used. As another example, in some embodiments, playlist indicator 126 can include a text numeral, which can indicate the number of media content items within the playlist. In some embodiments, playlist indicator 126 can be omitted.

Although the individual media interfaces 110, 120, and 130 shown in FIG. 1 include titles, thumbnail images, and a playlist indicator, in some embodiments, any other suitable information based on metadata associated with the corresponding media content items can be included. For example, in some embodiments, an individual media interface can indicate the name of the creator of an item of media content represented by the media interface. As another example, in some embodiments, an individual media interface can indicate the number of views an item of media content represented by the media interface has received. As yet another example, in some embodiments, an individual media interface can indicate that a contact (e.g., a friend, an acquaintance, a friend of a friend, and/or any other suitable contact) of a user has watched and/or rated an item of media content represented by the media interface.

Selection of display controls 106 and 108 can cause the media interfaces presented on user interface 100 to scroll. For example, in some embodiments, selection of display control 106 can cause the currently presented media interfaces to scroll to the right and can cause alternative media interfaces to be presented to the left of media interface 110. Similarly, selection of display control 108 can cause the currently presented media interfaces to scroll to the left and can cause alternative media interfaces to be presented to the right of media interface 130. Display controls 106 and/or 108 can operate in any suitable manner. For example, in some embodiments, selection of display controls 106 and/or 108 can cause all of the currently presented media interfaces to scroll out of a viewport of the presented user interface, and can cause a new set of media interfaces to be presented instead. As another example, in some embodiments, selection of display controls 106 and/or 108 can cause a subset of the currently presented media interfaces (e.g., one, two, and/or any other suitable number) to scroll out of a viewport of the presented user interface, which can be replaced with a corresponding number of alternative media interfaces.

As shown in FIG. 1, display controls 106 and/or 108 can be located to the left and/or right of set of media interfaces 104. Additionally or alternatively, display controls 106 and/or 108 can be located in any suitable location (e.g., above and/or below set of media interfaces 104, and/or any other suitable location). Although two display controls are shown in FIG. 1, any suitable number of display controls, including none, can be included in user interface 100.

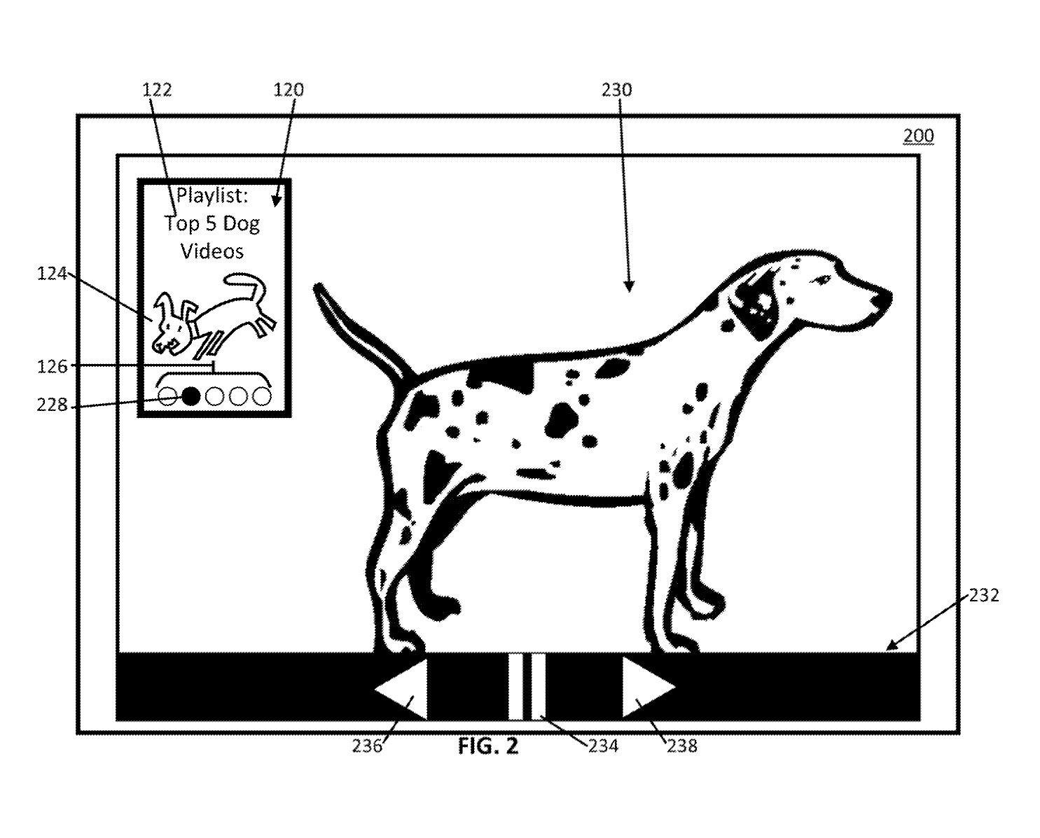

In some embodiments, an individual media interface can be a selectable object. In such embodiments, selection of an individual media interface can cause the media content item represented by the selected media interface to be presented. For example, if a media interface associated with a video content item is selected, the video content item can be played back in a media player window. As another example, if a media interface associated with a playlist containing two or more videos content items is selected, the first video content item in the collection of videos can be presented in a media player window. In some embodiments, as shown in FIG. 2, the selected media interface can be concurrently presented with the media content item associated with the selected media interface.

FIG. 2 shows an example 200 of a user interface for concurrently presenting a media interface and an associated item of media content in accordance with some embodiments. As shown, user interface 200 can include an item indicator 228, media content 230, and media player controls 232.

Note that, in FIG. 2, media interface 120 is presented concurrently with media content associated with media interface 120. As shown, a concurrently presented media interface can change visual appearance relative to its appearance within the media interfaces 104 in user interface 100 as shown in and described above in connection with FIG. 1. For example, in some embodiments, the concurrently presented media interface can become smaller relative to its size in user interface 100. As another example, in some embodiments, the concurrently presented media interface can be presented at a shifted position within user interface 200 relative to its position in user interface 100. As a more particular example, the concurrently presented media interface can be presented in a corner of user interface 200, as shown in FIG. 2. In some embodiments, the visual appearance of the concurrently presented media interface can change over time. For example, the concurrently presented media interface can shrink over time, scroll out of view, fade to disappearance, and/or be presented with any other suitable visual effects.

Item indicator 228 can be presented on the concurrently presented media interface (e.g., media interface 120 as shown in FIG. 2) and can indicate which item of media content within a playlist containing multiple media content items is currently being presented. Item indicator 228 can indicate which item is currently being presented in any suitable manner. For example, as shown in FIG. 2, item indicator 228 can be an icon which is colored in a manner which indicates which item from a set of items is being presented. In some embodiments, as different media content items from the playlist associated with media interface 120 are presented, item indicator 228 can be changed accordingly. In some embodiments, as described above, multiple item indicators can be presented—e.g., one item indicator which is colored in a manner which indicates which media content item from the list of media content items is currently being presented and another item indicator which is colored in a manner which indicates which media content item from the list of media content items that the user has navigated to. In some embodiments, item indicator 228 can include any suitable text, icons, images, graphics, animations, and/or any other suitable content. In some embodiments, item indicator 228 can be omitted.

Media content 230 can be any suitable media content associated with a selected media interface, such as media interface 120 in FIG. 2. For example, in some embodiments, media content 230 can be a video. In the particular example of FIG. 2, media content 230 can be a video from a playlist containing two or more videos. As yet another example, in some embodiments, media content 230 can be an item of audio content, an image, a slideshow of images, an album of songs, etc.

It should be noted that media content 230 can be stored locally on a device executing process 500 described herein and/or remotely. For example, media content can include video files or audio files that are stored locally and can be played back, copied, deleted, organized and/or otherwise used by the device executing process 500. As another example, media content 230 can include streaming media content such as streaming video content items, streaming audio content items, live streamed video, live streamed audio, and/or any other media content that can be streamed by the device executing process 500. As still another example, media content 230 can include media content available for download to the device executing process 500 by purchasing the media content, borrowing the media content, renting the media content, as a freely downloadable piece of media content, etc.

Media player controls 232 can be any suitable controls used for controlling the presentation of media content 230. For example, as shown in FIG. 2, media player controls 232 can include a pause button 234, a rewind button 236 and a fast-forward button 238. Although three buttons are shown in media player controls 232, in some embodiments, any suitable number of buttons can be included. For example, in some embodiments, buttons and/or controls corresponding to volume adjustment, screen maximization, and/or any other suitable controls can be included. In some embodiments, media player controls 232 can be fixed at a location within a player window and can be permanently displayed. In some other embodiments, presentation of media player controls 232 can be triggered by a user action, for example, by a user moving a cursor over a particular area of the media player window. In some embodiments, media player controls 232 can be omitted.

Pause button 234, rewind button 236, and fast-forward button 238 can be used to control the presentation of media content 230. For example, in some embodiments, pause button 234 can be used to pause the presentation of media content 230. In some embodiments, if pause button 234 is selected (e.g., using a suitable user input device), pause button 234 can be replaced with a play button (not shown). As another example, rewind button 236 can be used to rewind media content 230 to an earlier point in the media content than what is currently being presented. Similarly, fast-forward button 238 can be used to skip media content 230 to a later point in the media content than what is currently being presented.

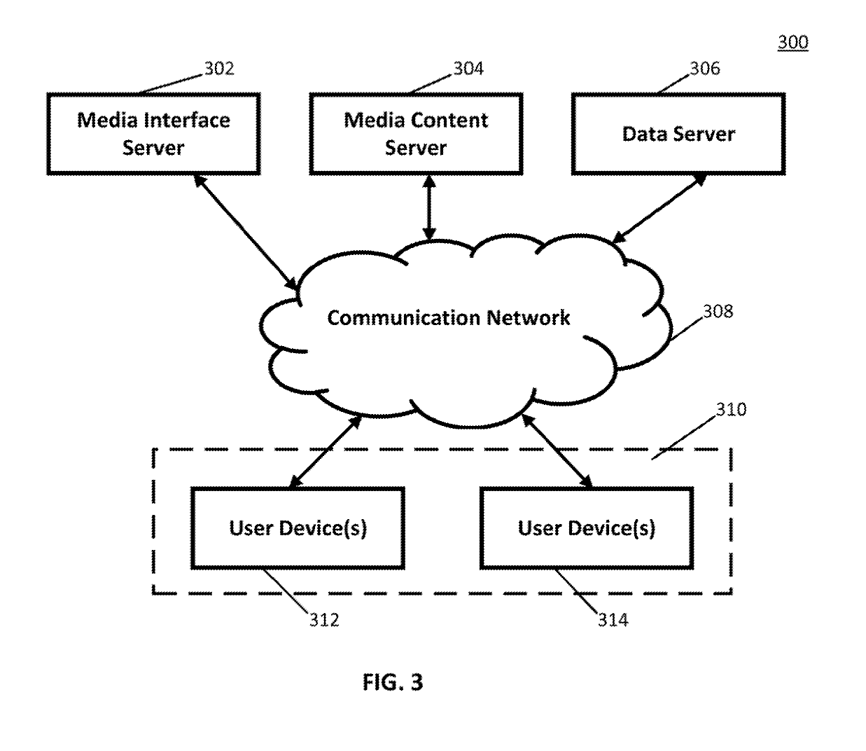

Turning to FIG. 3, an example 300 of hardware for media guidance that can be used in accordance with some embodiments is shown. As illustrated, hardware 300 can include one or more servers, including media interface server 302, media content server 304, and data server 306, a communication network 308, and one or more user devices 310, such as user devices 312 and 314.

Media interface server 302 can be any suitable server for storing media interfaces and/or parameters associated with media interfaces and for presenting media interfaces to a user device 310 in some embodiments. For example, media interface server 302 can store parameters associated with the appearance of media interfaces (e.g., colors, images, icons, and/or any other suitable parameters). Additionally or alternatively, media interface server 302 can serve media interfaces to user device 310 via communication network 308. In some embodiments, media interface server 302 can be omitted.

Media content server 304 can be any suitable server for storing media content and delivering the content to a user device 310 in some embodiments. For example, media content server 302 can be a server that streams media content to user device 310 via communication network 308. Media content provided by media content server 302 can be any suitable content, such as video content, audio content, television programs, movies, cartoons, sound effects, audiobooks, streaming live content (e.g., a streaming radio show, a live concert, and/or any other suitable type of streaming live content), electronic books, and/or any other suitable type of media content. Media content can be created and uploaded to media content server 302 by any suitable entity. In some embodiments, media content server 302 can be omitted.

Data server 306 can be any suitable server for storing data, programs, and/or any other suitable information. For example, in instances where a user has consented to use of previously watched media content items to select and/or create media interfaces, data server 306 can store information relating to media content items a user has previously watched. As a more particular example, in some embodiments, data server 306 can store indications of media content items watched by a user, indications of one or more genres frequently watched by a user, and/or any other suitable information. In some embodiments, data server 306 can transmit indications of media content items a user has previously watched to media interface server 102. In some embodiments, data server 306 can be omitted.

Communication network 308 can be any suitable combination of one or more wired and/or wireless networks in some embodiments. For example, communication network 308 can include any one or more of the Internet, a mobile data network, a satellite network, a local area network, a wide area network, a telephone network, a cable television network, a WiFi network, a WiMax network, and/or any other suitable communication network.

User devices 310 can include any one or more user devices suitable for receiving and/or presenting media content items and/or media interfaces. For example, in some embodiments, user devices 310 can include mobile devices, such as a mobile phone, a tablet computer, a laptop computer, a vehicle (e.g., a car, boat, airplane, or any other suitable vehicle) entertainment system, a portable media player, or any other suitable mobile device. As another example, in some embodiments, user devices 310 can include non-mobile devices such as a desktop computer, a set-top box, a television, a streaming media player, a game console, or any other suitable non-mobile device.

Although media interface server 302, media content server 304, and data server 306 are illustrated as separate devices, any one or more of these devices can be combined into one device in some embodiments. Also, although only one each of media interface server 302, media content server 304, and data server 306 are shown in FIG. 3 to avoid over-complicating the figure, any suitable one or more of each device can be used in some embodiments.

Although two user devices 312 and 314 are shown in FIG. 3 to avoid over-complicating the figure, any suitable number of each of these devices, and any suitable types of these devices, can be used in some embodiments.

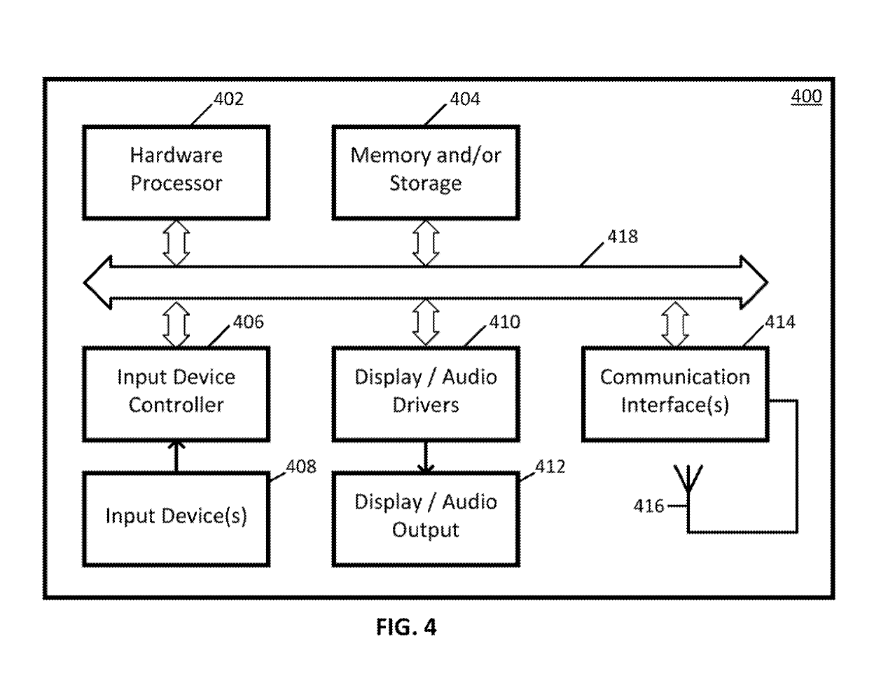

Media interface server 302, media content server 304, data server 306, and user devices 310 can be implemented using any suitable hardware in some embodiments. For example, in some embodiments, devices 302, 304, 306, and 310 can be implemented using any suitable general purpose computer or special purpose computer. For example, a mobile phone may be implemented using a special purpose computer. Any such general purpose computer or special purpose computer can include any suitable hardware. For example, as illustrated in example hardware 400 of FIG. 4, such hardware can include hardware processor 402, memory and/or storage 404, an input device controller 406, an input device 408, display/audio drivers 410, display and audio output circuitry 412, communication interface(s) 414, an antenna 416, and a bus 418.

Hardware processor 402 can include any suitable hardware processor, such as a microprocessor, a micro-controller, digital signal processor(s), dedicated logic, and/or any other suitable circuitry for controlling the functioning of a general purpose computer or a special purpose computer in some embodiments.

Memory and/or storage 404 can be any suitable memory and/or storage for storing programs, data, media content, and/or any other suitable information in some embodiments. For example, memory and/or storage 404 can include random access memory, read-only memory, flash memory, hard disk storage, optical media, and/or any other suitable memory.

Input device controller 406 can be any suitable circuitry for controlling and receiving input from one or more input devices 408 in some embodiments. For example, input device controller 406 can be circuitry for receiving input from a touch screen, from one or more buttons, from a remote control, from keyboard, from a mouse, from a voice recognition circuit, from a microphone, from a camera, from an optical sensor, from an accelerometer, from a temperature sensor, from a near field sensor, and/or any other type of input device.

Display/audio drivers 410 can be any suitable circuitry for controlling and driving output to one or more display/audio output circuitries 412 in some embodiments. For example, display/audio drivers 410 can be circuitry for driving an LCD display, a speaker, an LED, or any other type of output device.

Communication interface(s) 414 can be any suitable circuitry for interfacing with one or more communication networks, such as network 308 as shown in FIG. 3. For example, interface(s) 414 can include network interface card circuitry, wireless communication circuitry, and/or any other suitable type of communication network circuitry.

Antenna 416 can be any suitable one or more antennas for wirelessly communicating with a communication network in some embodiments. In some embodiments, antenna 416 can be omitted when not needed.

Bus 418 can be any suitable mechanism for communicating between two or more components 402, 404, 406, 410, and 414 in some embodiments.

Any other suitable components can be included in hardware 400 in accordance with some embodiments.

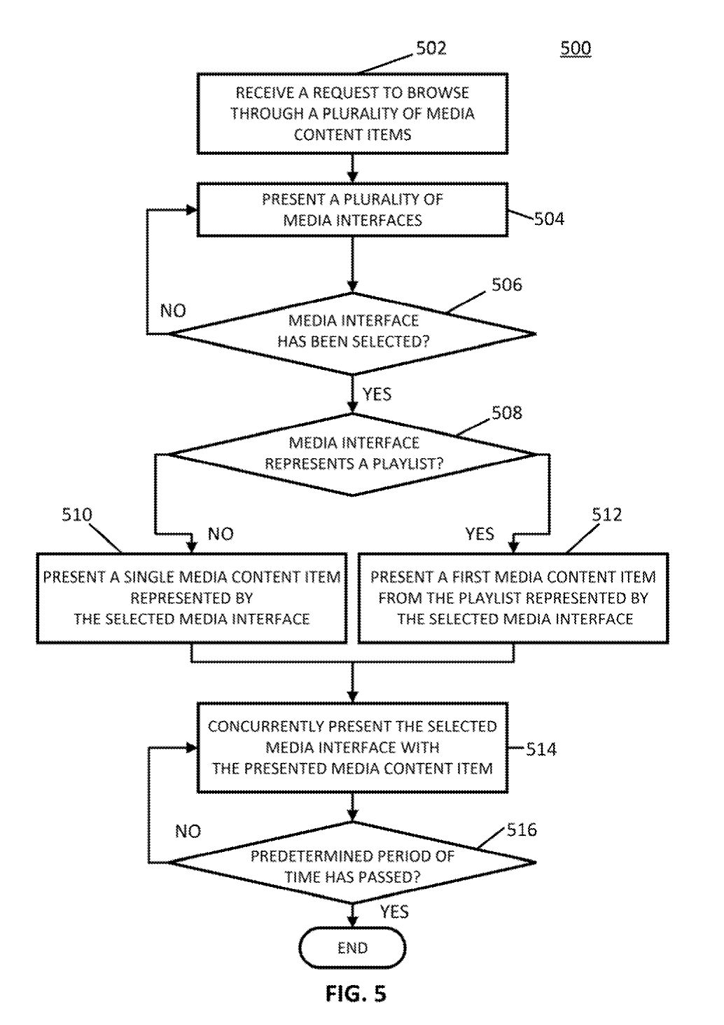

Turning to FIG. 5, an example 500 of a process for displaying media interfaces, receiving a request to present one or more media content items represented by a selected media interface, and concurrently presenting the selected media interface and the one or more media content items represented by the selected media interface is illustrated in accordance with some embodiments.

Process 500 can begin by receiving a request to browse through media content items at 502. The request can be received from any suitable source. For example, in some embodiments, a request can be generated by a hardware processor determining that a particular web page has been loaded. As another example, in some embodiments, a request can be generated by a hardware processor determining that a user has entered a search query; the request can therefore indicate that media content items which satisfy the parameters of the search query should be presented.

At 504, process 500 can present one or more media interfaces in response to receiving the request. The one or more media interfaces can be presented in any suitable manner. For example, in some embodiments, the one or more media interfaces can be presented in a row, as shown in and described in connection with FIG. 1. In some embodiments, user interface components (e.g., buttons, and/or any other suitable type of component), such as display controls 106 and/or 108, can be used to cause additional and/or alternative media interfaces to be presented. As another example, in some embodiments, the one or more media interfaces can be presented in a grid of two or more rows. As a more particular example, in some embodiments, a row can be associated with a particular genre of media content (e.g., comedies, documentaries, music, and/or any other suitable genres).

Process 500 can determine if a media interface has been selected at 506. This determination can be made using any suitable technique or combination of techniques and can be based on any suitable information. For example, in some embodiments, process 500 can determine if a media interface has been selected by determining if a particular input has been received by an input device associated with user device 310. As a more particular example, process 500 can determine if a particular area associated with a media interface has been touched and/or clicked, if a particular button and/or combination of buttons on a remote control device have been selected, and/or if any other suitable input has been received.

If, at 506, it is determined that no media interface has been selected (“No” at 506), process 500 can loop back to 504 and continue to present one or more media interfaces in a user interface.

Alternatively, if, at 506, it is determined that a media interface has been selected (“Yes” at 506), process 500 can determine if the selected media interface represents a playlist or collection of media content items at 508. The determination can be made based on any suitable information and using any suitable technique or combination of techniques. For example, in some embodiments, a media interface can be associated with an indicator whose state indicates whether the media interface represents a single media content item or a playlist. As a more particular example, in some embodiments, the indicator can include a value which can specify the number of media content items represented by the media interface. In such embodiments, process 500 can evaluate the content of the indicator to determine if the selected media interface represents a collection of two or more media content items.

If, at 508, it is determined that the selected media interface does not represent a playlist of media content items (“No” at 508), process 500 can cause the single media content item represented by the selected media interface to be presented at 510. The media content item can be presented in any suitable manner. For example, in some embodiments, the media content item can be presented in a media player window, as shown in and described in connection with FIG. 2. The media content item can be presented with any suitable technique or combination of techniques. For example, in some embodiments, the media content item can be transmitted from media content server 304 and received by user device 310 via communication network 308.

If, at 508, it is determined that the selected media interface represents a playlist or collection of media content items (“Yes” at 508), process 500 can cause the first media content item of the playlist to be presented at 512. Similarly to at 510, process 500 can cause the first media content item to be presented in any suitable manner, for example, in a media player window. In some embodiments, when it is determined that the first media content item has been presented in its entirety, process 500 can cause the next media content item to be presented. In some embodiments, all of the media content items contained in the playlist can be presented in this manner. Additionally or alternatively, in some embodiments, a media content item within a playlist can be skipped over, for example, if it is determined that a particular input (e.g., a particular directional input, a particular keystroke, a particular mouse click, and/or any other type of input) has been received from a suitable user input device.

Process 500 can cause the selected media interface to be presented concurrently with the presented media content item at 514. The selected media interface can be presented concurrently in any suitable manner. For example, in some embodiments, the selected media interface can be presented in a corner of the media player window in which the media content item is being presented, as shown in and described in connection with FIG. 2. As another example, in some embodiments, if the selected media interface represents a playlist, an indicator on the concurrently presented media interface (e.g., playlist indicator 228 as shown in FIG. 2) can be updated to indicate which media content item is currently being presented.

The selected media interface can be presented with any suitable technique or combination of techniques. For example, in some embodiments, the media interface or parameters associated with the media interface can be transmitted from a media interface server 302 to a user device 310 via communication network 308. In some embodiments, hardware processor 402 on the user device 310 direct display/audio drivers 410 to present the media interface to display/audio output 412. In some embodiments, a media interface received by user device 310 can be either presented immediately or can be stored in memory 404 for future presentation.

In some embodiments, the concurrently presented media interface can be interacted with while the associated media content item is being presented. For example, in some embodiments, interaction with the media interface can cause additional and/or alternative media interfaces to be presented within the media player window, thereby allowing the user to browse or navigate through additional media content items while the media content item is being presented. As a more particular example, in some embodiments, process 500 can determine that one or more additional and/or alternative media interfaces are to be presented in response to receiving a particular input (e.g., a click from a mouse and/or keyboard, a tap on a touchscreen, a particular button press from a remote control, and/or any other suitable input). In such embodiments, a second media interface can be selected, which can cause a media content item associated with the second media interface to begin being presented within the media player window.

Process 500 can determine if a predetermined period of time during which the selected media interface is to be concurrently presented with the associated media content item has passed at 516. The predetermined period of time can be any suitable time period, such as five seconds, ten seconds, a minute, two minutes, and/or any other suitable time period.

Process 500 can determine if the predetermined period of time has passed based on any suitable information and using any suitable technique or combination of techniques. For example, in some embodiments, the duration of the predetermined period of time can be stored in a variable, which can be accessed by a hardware processor (e.g., on a user device 310 and/or on a media interface server 302). Additionally or alternatively, in some embodiments, a hardware processor 402 can cause a timer to start in response to initiating presentation of the associated media content item, and hardware processor 402 can check if the timer has reached the predetermined period of time.

If, at 516, it is determined that the predetermined period of time has not passed (“No” at 516), process 500 can loop back to 514 and continue concurrently presenting the selected media interface and the associated media content item.

If, at 516, it is determined that the predetermined period of time has passed (“Yes” at 516), process 500 can cause the selected media interface to no longer be presented. In some embodiments, the selected media interface can be presented again for a second predetermined period of time after the predetermined period of time has passed. In such embodiments, the second predetermined period of time can be either the same or different from the predetermined period of time. For example, in some embodiments, the selected media interface can be presented again if it is determined that a particular input has been received (e.g., a user has selected a particular button, a user has tapped a screen of a user device, and/or any other type of input). As another example, in some embodiments, the selected media interface can be presented again in response to process 500 determining that presentation of the associated media content item is to end soon (e.g., within the next ten seconds, within the next thirty seconds, within the next minute, and/or any other suitable time period). As a more particular example, in some embodiments, process 500 can cause the media interface to appear before presentation of the media content item ends, thereby allowing a user to browse for and select another media content item to consume. As another more particular example, in instances where the media interface represents a playlist or a collection of media content items, process 500 can cause the media interface to appear before presentation of a media content item contained in the playlist ends, and can cause the media interface to be presented until after the next media content item in the playlist begins.

It should be understood that at least some of the above described blocks of the process of FIG. 5 can be executed or performed in any order or sequence not limited to the order and sequence shown in and described in the figures. Also, some of the above blocks of FIG. 5 can be executed or performed substantially simultaneously where appropriate or in parallel to reduce latency and processing times. Additionally or alternatively, some of the above described blocks of process of FIG. 5 can be omitted.

In some embodiments, any suitable computer readable media can be used for storing instructions for performing the functions and/or processes herein. For example, in some embodiments, computer readable media can be transitory or non-transitory. For example, non-transitory computer readable media can include media such as magnetic media (such as hard disks, floppy disks, and/or any other suitable magnetic media), optical media (such as compact discs, digital video discs, Blu-ray discs, and/or any other suitable optical media), semiconductor media (such as flash memory, electrically programmable read-only memory (EPROM), electrically erasable programmable read-only memory (EEPROM), and/or any other suitable semiconductor media), any suitable media that is not fleeting or devoid of any semblance of permanence during transmission, and/or any suitable tangible media. As another example, transitory computer readable media can include signals on networks, in wires, conductors, optical fibers, circuits, any suitable media that is fleeting and devoid of any semblance of permanence during transmission, and/or any suitable intangible media.

In situations in which the systems described here collect personal information about users, or make use of personal information, the users may be provided with an opportunity to control whether programs or features collect user information (e.g., information about a user's social network, social actions or activities, profession, a user's preferences, or a user's current location). In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over how information is collected about the user and used by a content server.

Although the invention has been described and illustrated in the foregoing illustrative embodiments, it is understood that the present disclosure has been made only by way of example, and that numerous changes in the details of implementation of the invention can be made without departing from the spirit and scope of the invention, which is limited only by the claims that follow. Features of the disclosed embodiments can be combined and rearranged in various ways.

What is claimed is:

1. A method for media guidance, comprising:
receiving a request to browse through a plurality of media content items;
causing, using a hardware processor, a plurality of media interfaces to be presented in response to receiving the request, wherein each of the plurality of media interfaces is a selectable object and includes information associated with a media content item placed within the interface;
determining that a media interface from the plurality of media interfaces has been selected;
causing a media content item corresponding to the selected media interface to be played back in a media player window in response to determining that the media interface has been selected; and
concurrently with causing the media content item to be played back in the media player window, causing the selected media interface to be presented for a predetermined period of time, wherein the selected media interface identifies the media content item.

2. The method of claim 1, wherein the information on each of the plurality of media interfaces is based on metadata associated with each of the plurality of media content items.

3. The method of claim 1, wherein the media content item represented by at least one of the plurality of media interfaces represents a plurality of media content items and wherein a first media content item from the plurality of media content items is presented in the player window.

4. The method of claim 1, wherein the media content item represented by at least one of the plurality of media interfaces is a single media content item and wherein the single media content item is presented in the player window.

5. The method of claim 1, further comprising:
receiving a request to change the concurrently presented selected media interface to a second media interface, wherein the second media interface represents an item of media content related to the media content being played back in the player window; and
causing the second media interface to be concurrently presented with the player window for a second predetermined period of time in response to the request.

6. The method of claim 5, further comprising:
determining that the second media interface has been selected; and
causing a media content item corresponding to the second media interface to be played back in the player window in response to determining that the second media interface has been selected.

7. The method of claim 1, further comprising:
causing the selected media interface to be presented for the predetermined period of time;
causing the selected media interface to no longer be presented after the predetermined period of time;
receiving a request to display the selected media interface after the predetermined period of time; and
causing the selected media interface to be concurrently presented with the player window for a third predetermined period of time.

8. The method of claim 1, further comprising modifying one or more visual features of the selected media interface in response to playing back the corresponding media content item in the media player window.

9. A system for media guidance, the system comprising:
a hardware processor that is configured to:
receive a request to browse through a plurality of media content items;
cause a plurality of media interfaces to be presented in response to receiving the request, wherein each of the plurality of media interfaces is a selectable object and includes information associated with a media content item placed within the interface;
determine that a media interface from the plurality of media interfaces has been selected;
cause a media content item corresponding to the selected media interface to be played back in a media player window in response to determining that the media interface has been selected; and
concurrently with causing the media content item to be played back in the media player window, cause the selected media interface to be presented for a predetermined period of time, wherein the selected media interface identifies the media content item.

10. The system of claim 9, wherein the information on each of the plurality of media interfaces is based on metadata associated with each of the plurality of media content items.

11. The system of claim 9, wherein the media content item represented by at least one of the plurality of media interfaces represents a plurality of media content items and wherein a first media content item from the plurality of media content items is presented in the player window.

12. The system of claim 9, wherein the media content item represented by at least one of the plurality of media interfaces is a single media content item and wherein the single media content item is presented in the player window.

13. The system of claim 9, wherein the hardware processor is further configured to:
receive a request to change the concurrently presented selected media interface to a second media interface, wherein the second media interface represents an item of media content related to the media content being played back in the player window; and
cause the second media interface to be concurrently presented with the player window for a second predetermined period of time in response to the request.

14. The system of claim 13, wherein the hardware processor is further configured to:
determine that the second media interface has been selected; and
cause a media content item corresponding to the second media interface to be played back in the player window in response to determining that the second media interface has been selected.

15. The system of claim 9, wherein the hardware processor is further configured to:
cause the selected media interface to be presented for the predetermined period of time;
cause the selected media interface to no longer be presented after the predetermined period of time;
receive a request to display the selected media interface after the predetermined period of time; and
cause the selected media interface to be concurrently presented with the player window for a third predetermined period of time.

16. The system of claim 9, wherein the hardware processor is further configured to modify one or more visual features of the selected media interface in response to playing back the corresponding media content item in the media player window.

17. A non-transitory computer-readable medium containing computer executable instructions that, when executed by a processor, cause the processor to perform a method for media guidance, the method comprising:
receiving a request to browse through a plurality of media content items;
causing a plurality of media interfaces to be presented in response to receiving the request, wherein each of the plurality of media interfaces is a selectable object and includes information associated with a media content item placed within the interface;
determining that a media interface from the plurality of media interfaces has been selected;
causing a media content item corresponding to the selected media interface to be played back in a media player window in response to determining that the media interface has been selected; and
concurrently with causing the media content item to be played back in the media player window, causing the selected media interface to be presented for a predetermined period of time, wherein the selected media interface identifies the media content item.

18. The non-transitory computer-readable medium of claim 17, wherein the information on each of the plurality of media interfaces is based on metadata associated with each of the plurality of media content items.

19. The non-transitory computer-readable medium of claim 17, wherein the media content item represented by at least one of the plurality of media interfaces represents a plurality of media content items and wherein a first media content item from the plurality of media content items is presented in the player window.

20. The non-transitory computer-readable medium of claim 17, wherein the media content item represented by at least one of the plurality of media interfaces is a single media content item and wherein the single media content item is presented in the player window.

21. The non-transitory computer-readable medium of claim 17, wherein the method further comprises:
receiving a request to change the concurrently presented selected media interface to a second media interface, wherein the second media interface represents an item of media content related to the media content being played back in the player window; and
causing the second media interface to be concurrently presented with the player window for a second predetermined period of time in response to the request.

22. The non-transitory computer-readable medium of claim 21, wherein the method further comprises:
determining that the second media interface has been selected; and
causing a media content item corresponding to the second media interface to be played back in the player window in response to determining that the second media interface has been selected.

23. The non-transitory computer-readable medium of claim 17, wherein the method further comprises:
causing the selected media interface to be presented for the predetermined period of time;
causing the selected media interface to no longer be presented after the predetermined period of time;
receiving a request to display the selected media interface after the predetermined period of time; and
causing the selected media interface to be concurrently presented with the player window for a third predetermined period of time.

24. The non-transitory computer-readable medium of claim 17, wherein the method further comprises modifying one or more visual features of the selected media interface in response to playing back the corresponding media content item in the media player window.
